(19) United States
(12) Patent Application Publication
(10) Pub. No.: US 2011/0097632 A1
(43) Pub. Date: Apr. 28, 2011

(54) Air supply unit for a fuel cell stack, fuel cell system and method for operating an air supply unit

(76) Inventors: Siegfried Sumser, Stuttgart (DE); Manfred Stute, Esslingen (DE)

(21) Appl. No.: 12/927,867

(22) Filed: Nov. 27, 2010

Related U.S. Application Data
(63) Continuation-in-part of application No. PCT/EP2009/006551, filed on Sep. 9, 2009.

(30) Foreign Application Priority Data
Sep. 30, 2008 (DE) 10 2008 049 689.8

(51) Int. Cl. H01M 8/06; H01M 8/24

(52) U.S. Cl. 429/408; 429/462; 429/456

(57) ABSTRACT

In an air supply unit for a fuel cell stack comprising a compressor for compressing air that is fed via a feed line to the fuel cell stack and to a turbine to which also exhaust gas of a combustion chamber can be supplied and wherein an exhaust gas from the combustion chamber is supplied to the turbine, the feed line to the fuel cell stack is in communication with a branch line by way of which compressed air can be fed also to the combustion chamber. The invention further relates to a method for operating an air supply unit for the fuel cell system.

This is a Continuation-In-Part Application of pending international patent application PCT/EP2009/006551 filed Sep. 9, 2009 and claiming the priority of German patent application 10 2008 049 689.8 filed Sep. 30, 2008.

### BACKGROUND OF THE INVENTION

The invention relates to an air supply unit for a fuel cell stack, with a compressor for compressing air and directing it from the fuel cell stack via a feed line, a turbine to which exhaust air of the fuel cell stack can be fed for driving the compressor, and a combustion chamber to which fuel can be supplied, wherein exhaust gas of the combustion chamber can be applied to the turbine. The invention further relates to a fuel cell system with a fuel supply unit for feeding air to a fuel cell stack and to a method for operating an air supply unit for a fuel cell stack.

From the motor vehicle technology an air supply unit for a fuel cell stack is known which has a high analogous part to an air supply unit for an internal combustion engine. Even though the fuel cell drive and the drive by means of the internal combustion engine are different with regard to their function and their construction, the air supply unit based on the exhaust gas turbocharger has been proven to be a very effective flow generating machine for supplying the fuel cell stack with air. The fuel cell stack provides electrical energy for driving the motor vehicle.

With the air supply unit for the fuel cell stack, which has a compressor for compressing air that can be fed from the fuel cell stack via a feed line, a turbine is provided for driving the compressor, to which exhaust air of the fuel cell stack can be supplied. Additionally, a combustion chamber that can be supplied with fuel is known from the state of the art, wherein the turbine can be supplied with exhaust gas from the combustion chamber. By means of this additional application of the turbine with exhaust gas of the combustion chamber, a booster function is provided, by means of which an increased performance of the fuel cell stack can be achieved at short notice and comparatively quickly, in that a particularly large mass flow of air is fed to the fuel cell stack. If an electrical drive assembly is provided for driving the compressor, this does not have to be designed with regard to a performance demand, which enables a provision of this particularly high mass flow conveyed by the compressor.

It is the object of the present invention to provide an air supply unit for a fuel cell stack with a turbine-driven compressor for compressing air to be supplied to the fuel cell stack and a method of providing for a particularly effective drive of the turbine operating the compressor.

### SUMMARY OF THE INVENTION

In an air supply unit for a fuel cell stack comprising a compressor for compressing air that is fed via a feed line to the fuel cell stack and to a turbine to which also exhaust gas of a combustion chamber can be supplied and wherein an exhaust gas from the combustion chamber is supplied to the turbine, the feed line to the fuel cell stack is in communication with a branch line by way of which compressed air can be fed also to the combustion chamber. The invention further relates to a method for operating an air supply unit for the fuel cell system.

With a turbine operated by exhaust air of the fuel cell stack for driving the compressor and with a combustion chamber in which fuel is combusted with air to produce an exhaust gas for driving the turbine, compressed air is also supplied to the combustion chamber via the branch line.

The invention is based on the knowledge that a particularly effective drive of the turbine is achieved if air with a comparatively large oxygen content is supplied to the combustion chamber. If compressed air is thus supplied to the combustion chamber as an oxidation means, in the combustion chamber a radial chain reaction takes place after the supply of the fuel and after ignition causing a particularly high energy release. The particularly energy-rich exhaust gas of the combustion chamber causes a particularly effective drive of the turbine.

The relatively high performance of the turbine caused by the supply to the turbine of exhaust gas from the combustion chamber leads to an increased supply of air to the fuel cell stack by the compressor, so that the performance of the fuel cell stack is improved. When using this booster function that can in particular be rapidly be initiated, the main part of the air compressed by the compressor is fed to the fuel cell stack and used for electric generation. The partial flow of the air branched off at the branch line however increases the supply of energy-rich exhaust gas to the gas turbine by the combustion of the gas in the combustion chamber and thus an increase of the performance of the fuel cell stack.

Bypassing of the fuel cell stack with the partial flow of the air via the branch line can also be carried out when no fuel is fed to the combustion chamber, so that no combustion takes place in the combustion chamber. The bypass then established by the branch line forms a flow passage in parallel with the fuel cell stack. When operating the compressor close to its pump limit, a larger mass flow can be provided by the compressor with a given pressure ratio and a pumping of the compressor can thus be avoided. For maintaining the given pressure ratio with a larger mass flow, the necessary power has to be provided to the compressor by a drive assembly separate from the turbine, for example by an electric motor.

It is conceivable to supply the exhaust air of the fuel cell stack to the combustion chamber at least as supplemental air, in order to use residual oxygen present in the exhaust air of the fuel cell stack for the combustion.

In an advantageous arrangement of the invention, the turbine has two inlet channels, wherein a first spiral inlet channel may carry exhaust gas of the combustion chamber and a second spiral channel exhaust air of the fuel cell stack. The comparatively cool exhaust air of the fuel cell can thus be fed to the same turbine as the comparatively hot exhaust gas of the combustion chamber. While the exhaust air of the fuel cell stack does not considerably exceed temperatures of 100° C., the temperature of the exhaust gas of the combustion chamber is for example 600 to 700° C. The exhaust gas and exhaust air flows supplied to the two-flow turbine thus have a different composition, different inlet temperatures and different inlet pressures.

The first spiral channel and the second spiral channel can be designed in such a manner that the exhaust gas of the combustion chamber and the exhaust air of the fuel cell stack only meet directly upstream of a turbine wheel of the turbine. It is also conceivable to maintain a separation of the flows up into the region of the turbine wheel.

If a combustion chamber flow rate parameter given for the first spiral channel is considered, which can be calculated as the mass flow m_{BK} through the first spiral channel multiplied by the square root of the temperature T_{BK} of the exhaust gas and divided by the pressure P_{BK} of the exhaust gas of the combustion chamber, it can have a comparable magnitude as a fuel cell stack flow rate parameter due to the high temperature T_{BK} of the exhaust gas and the comparatively low mass flow m_{BK}. The fuel cell stack flow rate parameter, which can be calculated as mass flow m_{BZ} of the exhaust air of the fuel cell stack multiplied by the square root of the temperature T_{BZ} of the exhaust air and divided by the pressure P_{BZ}, hereby characterizes the flow rate through the second spiral channel. The combustion chamber flow rate parameter can have a value of 1. With a fuel cell stack flow rate parameter having a comparable magnitude, a comparatively large mass flow m_{BZ} is present with a comparable low temperature.

In a further advantageous embodiment of the invention, a flow cross section of the second spiral channel is larger than a flow cross section of the first spiral channel. The two-flow path and asymmetric turbine given hereby is for example especially suitable for driving the compressor if the combustion chamber flow rate parameter has the value 1 in magnitude and the fuel cell stack flow rate parameter has the value 1.5. A particularly high efficiency of the turbine during normal operation and also during booster operation, when exhaust gas from the combustion chamber is supplied to the turbine, is thereby achieved.

It has further been shown to be advantageous if the second spiral channel is arranged closer to a bearing of a shaft supporting a turbine wheel of the turbine and a compressor wheel of the compressor than the first spiral channel. The second spiral channel, through which the comparatively cool exhaust air of the fuel cell stack flows acts as a thermal buffer, which results in a reduced thermal load of the shaft bearing.

In a further advantageous arrangement of the invention, for driving the compressor, the second spiral channel is arranged closer to an electrical drive assembly than the first spiral channel. The second spiral channel then acts as a thermal buffer with regard to the electrical drive assembly.

In another embodiment, a low pressure compressor is arranged upstream of the turbine-driven compressor and an electrical drive assembly is provided for driving the low pressure compressor. With a two-stage compression that can be achieved by means of two compressors connected in series, the efficiencies of the turbine-driven compressor and of the low pressure compressor can be improved.

It is herein of particular advantage if the compressor arranged downstream of the electrically drivable low pressure compressor does not have an electrical drive assembly, but rather is formed analogously to a turbocharger. By foregoing the provision of the compressor with an electrical drive assembly, there is no need to protect an electric drive assembly from the thermal load by the exhaust gas of the combustion chamber. Operation regions of the compressor formed as a high pressure compressor in this arrangement are thus essentially dependent on the energies which are provided to the turbine by the exhaust gas of the combustion chamber and/or by the exhaust air of the fuel cell stack. By additionally driving the low pressure compressor by means of the electrical drive assembly, a particularly broad performance region of the fuel cell stack can be achieved by the two-stage compression.

Additionally or alternatively, a high pressure compressor can be arranged down-stream of the turbine-driven compressor and provided with an electrical drive assembly for driving the high pressure compressor. The electrical drive assembly is also thermally decoupled from the compressor, whereby the turbine driving the compressor can be driven by the hot exhaust gas of the combustion chamber. If the compressor formed analogously to a known turbocharger, and having no electric drive, is arranged upstream of the high pressure compressor, the compressor can be designed for comparatively low specific speeds of for example less than 100,000 rotations per minute. With a design of such low specific speeds, comparatively large diameters of the compressor wheel and of the turbine wheel can be used. Thereby, less elaborate bearings can be used for the shaft which supports the turbine wheel and the compressor wheel.

A connection in series of two turbines is also conceivable in combination with a two-stage compression, the turbines respectively driving the low pressure compressor and the high pressure compressor. Hereby, both compressors can additionally be driven by an electrical drive assembly.

If a high pressure compressor is arranged downstream of the low pressure compressor, the branch line to the combustion chamber is preferably arranged down-stream of the high pressure compressor in the feed line. Particularly highly compressed air can thereby be fed to the combustion chamber.

In a further advantageous arrangement of the invention, a dosing device is provided for adjusting the air supply flow the combustion chamber. The dosing device preferably also permits a complete blocking of the branch line. The partial flow of the air to the combustion chamber can thereby be adjusted in dependence on the desired performance of the fuel cell stack.

It is further advantageous if the turbine has a throttle device for throttling and/or blocking at least the first spiral channel. In this case the dosing device which is arranged at the connection location of the branch line can be omitted as the dosing of the amount of the air by-passing the fuel cell stack via the branch line can take place by means of the throttle device, in particular if this permits a blocking of the first spiral channel. A vario slider can for example be provided as the throttle device, by means of which the first spiral channel can be blocked at the inlet to the turbine wheel. A blade height of blades of a turbine vane structure can hereby preferably be changed by means of the vario slider. Such a throttle device further permits a particularly fine adjustment of the exhaust gas amount of the combustion chamber applying the first spiral channel.

The throttle device can also be used for throttling and/or blocking the first spiral channel and the second spiral channel. A variability is thereby given for the first spiral channel and the second spiral channel.

In a further advantageous development of the invention, a dosing device is arranged upstream of the turbine, by means of which the exhaust gas of the combustion chamber can be fed to the first spiral channel and/or the second spiral channel together with the exhaust air of the fuel cell stack. The dosing device can comprise a rotary slider, which also makes a separate admission of exhaust gas to the combustion chamber or exhaust air of the fuel cell stack to the first and the second spiral channel possible.

Depending on the position of the rotary slide, all the gas from the combustion chamber and the exhaust air of the fuel cell stack can be fed mixed to the first spiral channel and the second spiral channel. Such a dosing device permits an adaptation of the supply of the exhaust air and/or the exhaust gas to the turbine with high efficiency depending on the respectively available momentary mass flow of the exhaust gas or the exhaust air. By means of the dosing device, a variable admission of gas to a two-flow turbine having a non-variable geometry can be achieved in a particularly simple and cost-efficient manner.

It is furthermore advantageous if the turbine is formed as a, in particular variable twin-flow turbine or segment turbine. With the twin-flow turbine, the variability can be achieved in a particularly simple and cost-efficient manner by means of the dosing device connected upstream thereof. However, variable twin-flow turbines can also be controllable at the turbine, for example by providing an axial slider. In contrast to this, a change of the flow rate behavior can be adjusted with the segment turbine by means of a rotatable tongue ring or the like, wherein a transfer of exhaust gas or exhaust air into the second or first spiral channel can be caused. Such a segment turbine is particularly simple and cost-efficient with regard to its construction. A segment turbine with a rigid, non-variable geometry however enables an effective drive of the compressor by means of the booster function.

It is furthermore advantageous if a common storage container is provided for storing fuel for the combustion chamber and the fuel cell stack. A complexity of the device is reduced thereby. The fuel can in particular be hydrogen gas.

In a further arrangement of the invention, an exhaust gas aftertreatment device can be arranged downstream of the turbine. This is particularly advantageous if during the combustion of the fuel, undesired exhaust gases, in particular nitrogen oxides, result in undesirably high concentrations. The exhaust gas aftertreatment device can comprise a simple Denox catalyst or the like.

A particularly effective drive of the turbine is achieved by a method for operating an air supply unit for a fuel cell stack, where a compressor compresses air fed to the fuel cell stack via a feed line, in which exhaust air of the fuel cell stack is fed to a turbine driving the compressor, and where fuel is supplied to a combustion chamber and exhaust gas of the combustion chamber is supplied to the turbine, and wherein compressed air is branched off from the feed line and via a branch line fed to the combustion chamber.

The described preferred embodiments and advantages described for the air supply unit according to the invention are also valid for the method for operating an air supply unit for a fuel cell stack according to the invention.

Further advantages, characteristics and details of the invention will become more readily apparent from the following description of preferred embodiments thereof with reference to the accompanying drawings, in which the same, or functionally the same, elements are provided with identical reference numerals.

### BRIEF DESCRIPTION OF THE DRAWINGS

FIG. 1 shows a first embodiment of an air supply unit for a fuel cell stack, which is connected to a drive assembly of a motor vehicle, wherein exhaust air of the fuel cell stack and exhaust gas of a combustion chamber can be fed to a two-flow turbine;

FIG. 2 is a sectional view of a two-flow twin flow turbine of the air supply unit according to claim 1;

FIG. 3 shows a second embodiment of an air supply unit for feeding the fuel cell stack with air;

FIG. 4 is a sectional view of a two-flow segment turbine of the air supply unit according to FIG. 3;

FIG. 5 shows a third embodiment of an air supply unit for feeding supply air to the fuel cell stack;

FIG. 6 is a sectional view of a variable two-flow turbine of the air supply unit according to FIG. 5;

FIG. 7 shows a fourth embodiment of an air supply unit for feeding air to the fuel cell stack, wherein a dosing device is arranged upstream of the two-flow turbine;

FIG. 8 is a sectional view of the dosing device according to FIG. 7 in a first dosing position; and

FIG. 9 is a sectional view of the dosing device according to FIG. 7 in a second dosing position.

### DESCRIPTION OF EXEMPLARY EMBODIMENTS

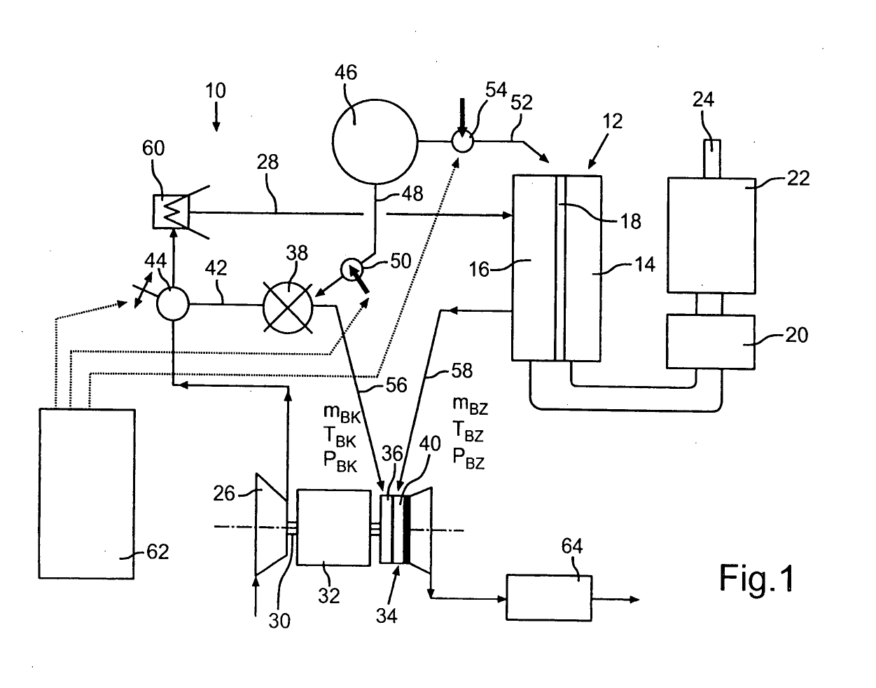

FIG. 1 schematically shows a first embodiment of an air supply unit 10 for supplying air to a fuel cell stack 12. The fuel cell stack 12 includes a plurality of individual fuel cells, wherein an anode chamber 14 is separated from a cathode chamber 16 by means of a membrane 18. The fuel cell stack 12 is connected to an accumulator 20 in an electrically conductive manner for storing the electrical energy generated by means of the fuel cell stack 12. The accumulator 20 is on its part connected to an electrical drive assembly, so that a drive train 24 of a motor vehicle (not shown) can be supplied with drive energy.

The air supply unit 10 comprises a compressor 26, by means of which compressed air can be fed to the fuel stack 12 via a feed line 28. For driving a shaft 30 of the compressor 26, an electrical drive assembly in the form of an electric motor 32 is provided. Furthermore, a two-flow turbine 34 is arranged at the shaft 30 of the compressor 26, by means of which turbine a compressor wheel of the compressor can be driven. To this end, exhaust gas from a combustion chamber 38 is supplied to a first spiral channel 36 of the turbine 34. Furthermore, exhaust air of the fuel cell stack 12 can be fed to a second spiral channel 40 of the turbine 34.

The feed line 28 leading from the compressor 26 to the fuel cell stack 12 has a branch line 42, by means of which compressed air can be fed from the compressor 26 to the combustion chamber 38. At a connection point of the branch line 42 to the feed line 28, a dosing device 44 is arranged as shown in FIG. 1 for adjusting a partial air flow to the combustion chamber 38.

For supplying fuel to the combustion chamber 38 a storage container 46, is provided in which hydrogen gas fuel is stored. A first line 48 leads to the combustion chamber 38 from this storage container 46, wherein the amount of the fuel that can be fed to the combustion chamber, can be adjusted by means of a first valve 50. By way of a second line 52 which has a second valve 54, fuel from the storage container 46 can be fed to the fuel cell stack 12.

Air compressed by means of the compressor 26 is supplied to the combustion chamber 38 and fuel is supplied from the storage container 46 to the combustion chamber 38 when an increased performance of the fuel cell stack 12 is demanded. Herein, exhaust gas is supplied from the combustion chamber 38 to the first spiral channel 36 of the turbine 34 as well as exhaust air is supplied from the fuel cell stack 12 to the second spiral channel 40 for a particularly high performance of the turbine 34. Accordingly, the compressor 26 driven by means of the turbine 34 provides a particularly large amount of compressed air to the fuel cell stack 12, whereby a particularly high performance of the fuel cell stack can be achieved. In that compressed air is supplied to the combustion chamber 38 and a particularly energy-rich combustion of the fuel in the combustion chamber 38 is obtained so that the turbine 34 can be driven particularly effectively by the exhaust gas of the combustion chamber 38 supplied to the first spiral channel 36.

In an exhaust gas strand 56 supplying the exhaust gas of the combustion chamber 38 to the first spiral channel 36 an exhaust gas is present which is characterized by a combustion chamber flow rate parameter. A mass flow m_{BK} of the exhaust gas flows into the combustion chamber flow rate, a temperature T_{BK} of the exhaust gas and a pressure P_{BK} of the exhaust gas. In an analogous manner, an exhaust air strand 58 guided from the fuel cell stack 12 to the second spiral channel 40 can be characterized by a fuel cell stack flow rate parameter. These characterize the mass flow m_{BZ} of the exhaust air, their temperature T_{BZ} and their pressure P_{BZ}.

The feed line 28 to the fuel cell stack 12 includes a charge-air cooler 60 down-stream of the dosing device 44 with the branch line 42. The air supply unit of the embodiment according to FIG. 1 further shows a control unit 62, by means of which the dosing device 44 and thus the main flow of the air that can be supplied to the fuel cell stack 12 and the valves 50, 54 and the partial mass dosing of the air that can be supplied to the combustion chamber can be controlled. When a partial air flow is admitted to the combustion chamber 38 via the branch line 42 and fuel is added to the combustion chamber 36, the exhaust gas in the combustion chamber is heated to 600 to 700° C. and expands as it is being admitted to a turbine wheel via the first spiral channel 36 for producing mechanical work. In an analogous manner, the exhaust air of the fuel cell stack 12 expands when supplied to the turbine wheel of the turbine 34 via the second spiral channel 40. An exhaust gas aftertreatment device 64 is connected downstream of the turbine 34.

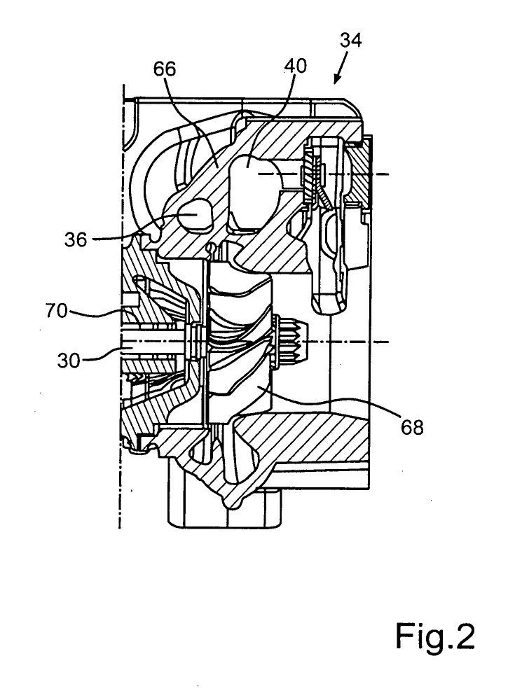

FIG. 2 shows the two-flow turbine 34 of the air supply unit 10 according to FIG. 1. In a sectional view, a turbine housing 66 includes the first spiral channel 36 and the second spiral channel 40. The cross section of the second spiral 40 is hereby larger than the cross section of the first spiral channel 36. The turbine is thus an asymmetric twin-flow turbine, whose turbine wheel 68 is supported by the shaft 30. In an alternative preferred embodiment of the asymmetric twin-flow turbine, the first spiral channel 36 guiding the exhaust gas of the combustion chamber 38 can be spaced further from a bearing 70 of the shaft 30 than the second spiral channel 40. The second spiral channel 40 guiding the comparatively cold exhaust air of the fuel cell stack 12 with not substantially more than 100° C. thereby serves as a thermal buffer with regard to the bearing 70 and the electric motor 32.

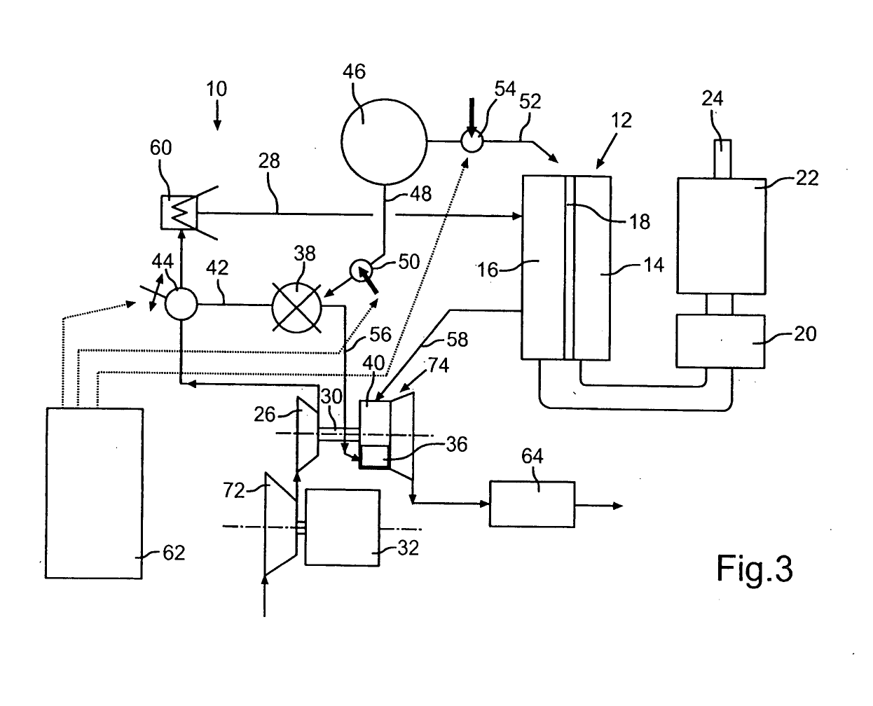

FIG. 3 shows a second embodiment of the air supply unit 10, wherein compressed air is supplied to the fuel cell stack 12 in two stages. A low pressure compressor 72 is hereby connected upstream of the compressor 26, which low pressure compressor is driven by means of the electric motor 32. In contrast to this, the shaft 30 of the compressor 26 is not driven by an electric motor, but via a two-flow turbine 74, which is formed as an asymmetric segment turbine. In an analogous manner to the twin-flow turbine shown in FIG. 1, the turbine 74 according to FIG. 3 has a first spiral channel 36 and a second spiral channel 40. Hereby, the first spiral channel 36 can be supplied with the exhaust gas of the combustion chamber 38, and the second spiral channel 40 with the exhaust air of the fuel cell stack 12.

The compressor 26, which presently functions as a high pressure compressor that can be operated in a particularly efficiency-favorable manner, has the energies of the exhaust gas of the combustion chamber 38 and of the exhaust air of the fuel cell stack 12 available for the drive. Otherwise, the air supply unit 10 corresponds to the embodiment shown in FIG. 1.

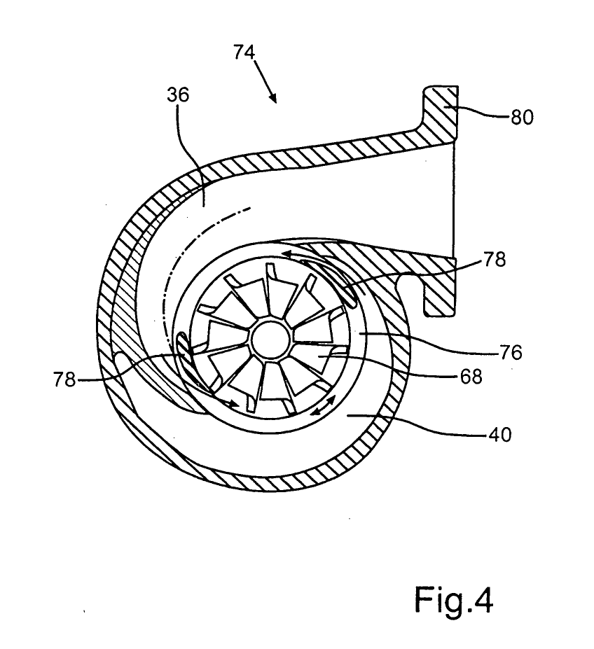

FIG. 4 shows the two-flow asymmetric segment turbine 74 according to FIG. 3 in a sectional view. The turbine 74 is in this case formed as a variable, asymmetric segment turbine. For varying the amount of exhaust gas or exhaust air that can be supplied to the turbine wheel 68 via the first spiral channel 36 or via the second spiral channel 30, a rotatable tongue slider 76 is provided. In the position of the tongue slider 76 shown in FIG. 4, its tongues 78 permit a transfer of the exhaust gas from the first spiral channel 36 into the second spiral channel 40 and of exhaust air from the second spiral channel 40 into the first spiral channel 36.

By rotating the tongue slider 76 counter-clockwise, the tongues 78 enable in contrast a separate application of the segments of the turbine wheel 68 with exhaust gas via the first spiral channel 36 and with exhaust gas via the second spiral channel 40. The turbine 74 herein has a twin passage flange 80, via which the exhaust gas strand 56 and the exhaust air strand 58 can be connected in parallel to the turbine 74.

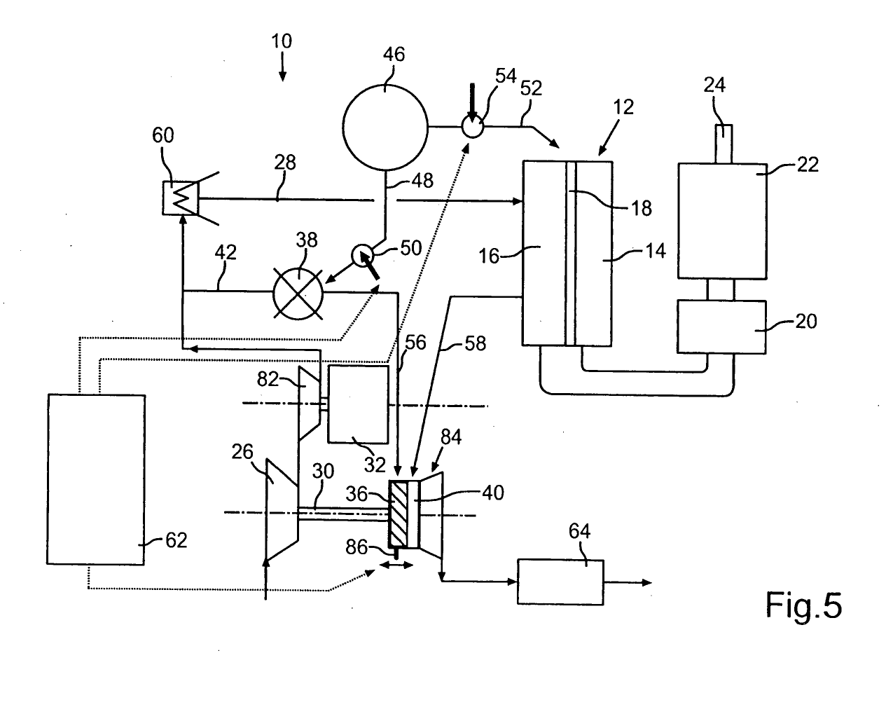

With the embodiment of the air supply unit 10 according to FIG. 5, where the fuel cell stack 12 can also be supplied with air compressed in two stages via the feed line 28, a high pressure compressor 82 is connected downstream if the compressor 26. The electric motor is hereby provided for driving the high pressure compressor 82, whereas the shaft 30 of the compressor 26 does not have an electrical drive assembly. Furthermore, a turbine 84 driving the compressor 26 is formed as a variable twin-flow turbine. With this turbine 84, the exhaust gas of the combustion chamber 38 can be fed to the first spiral channel 36 and the exhaust air of the fuel cell stack 12 to the second spiral channel 40.

The turbine 84 has however a throttle device 86 for throttling and blocking the first spiral channel 36. Since the first spiral channel 36 can be blocked by means of the throttling device 36, the dosing device 44 shown with the embodiment of the air supply unit 10 according to FIG. 5 is not needed. With a blocked first spiral channel 36, no compressed air flows through the branch line 42 extending from the feed line 28 to the combustion chamber.

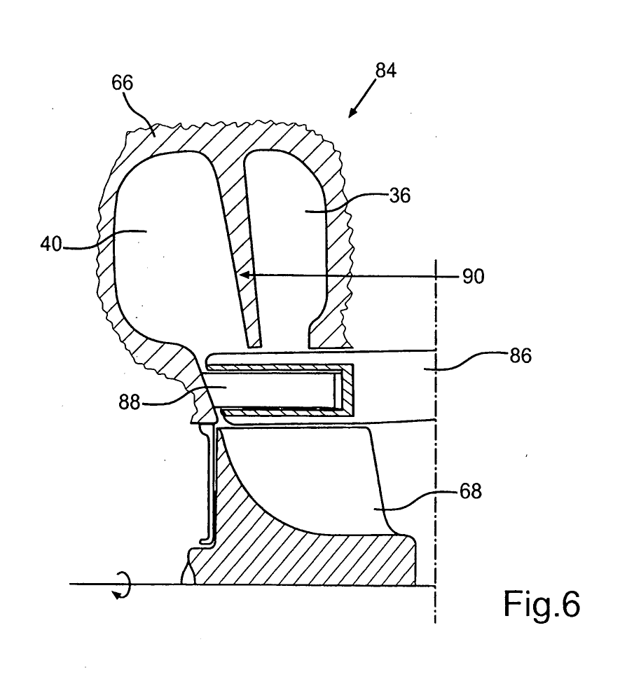

FIG. 6 shows the turbine 84 according to FIG. 5 in parts in a sectional view. As a throttle device 86, a vario slider is here arranged in the turbine housing 66, by means of which a surface of a turbine vane structure 88 that can opened or blocked can be changed. The vario slider is herein a die plate, by means of which the vanes of the turbine guide vane structure 88 can be covered to a different extent. In the position of the vario slider shown in FIG. 6, the turbine guide vane structure 88 is covered nearly completely by the die. Only a small flow cross section remains uncovered in this position by the vario slider, so that the exhaust air of the fuel cell stack 12 from the second spiral channel 40 flows into the region of the turbine housing receiving the turbine wheel 68 with a high flow velocity.

In contrast, the first spiral channel 36 to which the exhaust gas from the combustion chamber 38 is supplied, which herein has a lower flow cross section than the second spiral channel 40, is completely closed in the position shown in FIG. 6. Thus no exhaust gas flows from the first spiral channel 36 to the region of the turbine housing 66 receiving the turbine wheel 68.

By means of the vario slider, a variability of the application of the turbine guide blade 88 with exhaust air via the second spiral channel 40 and with exhaust gas via the first spiral channel is possible. The vario slider can hereby be axially displaced over an intermediate wall 90, which separates the first spiral channel 36 from the second spiral channel 40 in the axial direction. The intermediate wall 90 can extend in an alternative embodiment in the radial direction over the turbine guide blade 88 to the outer circumference of the turbine wheel 68. In this case, the vario slider is only suitable for blocking the first spiral channel 36 and correspondingly for varying the vane height of the turbine guide blade 88 in the region of the outlet from the first spiral channel 36. The vanes of the turbine guide vane structure 88 act as nozzles for accelerating the medium exiting from the spiral channels 40, 36 prior to its impingement on the turbine wheel 68.

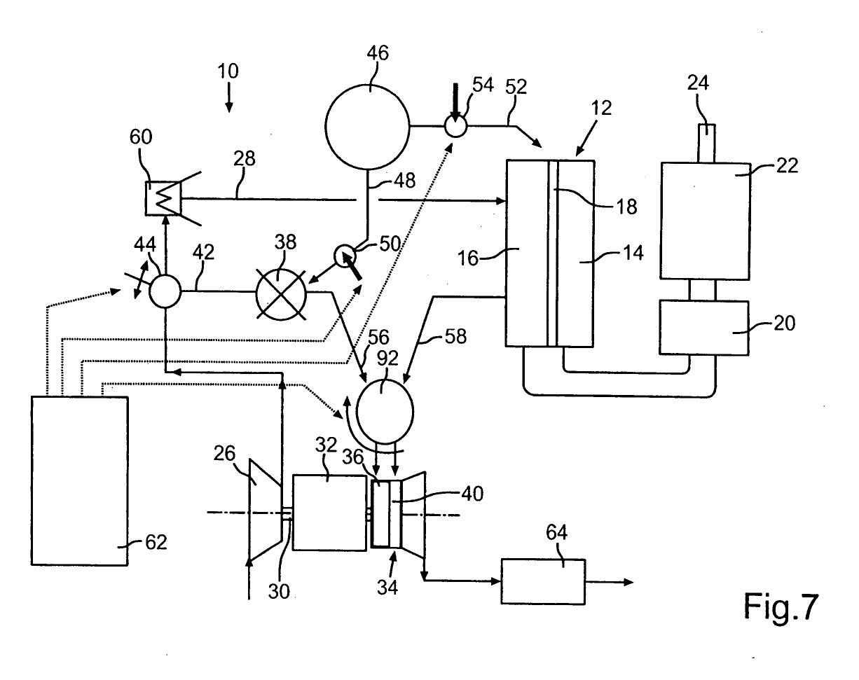

FIG. 7 shows a further embodiment of the air supply unit 10, which essentially corresponds to the embodiment according to FIG. 1. The turbine 34 is correspondingly formed as an asymmetric twin-flow turbine with a non-variable geometry. In order to still enable a variable application of exhaust gas and/or exhaust air to the turbine wheel 68, a dosing device 92 is arranged upstream of the turbine 34. This dosing device 92 permits a comparably coarse, but robust and cost-efficient supply of gas to the turbine wheel 68 via the first spiral channel 36 and/or the second spiral channel 40. The dosing device 92 furthermore permits a dosing of the compressed air inflowing via the branch line 42 of the combustion chamber 38. The dosing device 92 can be controlled with the embodiment according to FIG. 7 and at the connection point of the branch line 42 to the feed line and the valves 50, 54 by means of the control unit 62.

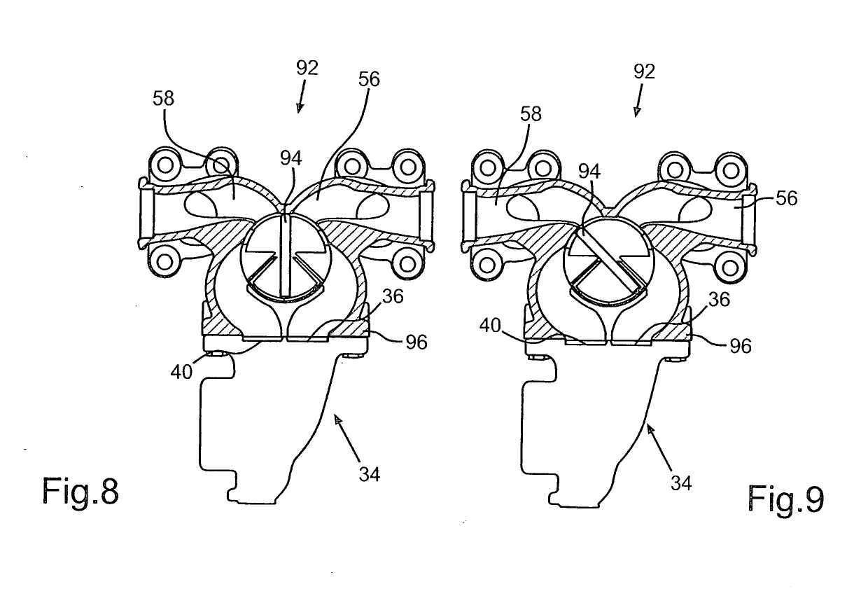

FIG. 8 shows the dosing device schematically shown in FIG. 7 in a sectional view. The dosing device 92 comprises a rotary slide 94, which is shown in FIG. 8 in a center position. In this center position, the exhaust air that can be supplied to the second spiral channel 40 via the exhaust air strand 58 is supplied to the turbine 34 without admixing exhaust gas from the exhaust gas strand 56. In an analogous manner, in this center position of the rotary slide 94, the exhaust gas flowing through the exhaust gas strand 56 coming from the combustion chamber 38 is supplied to the first spiral channel 36 of the turbine 34 without admixing exhaust air of the fuel cell stack 12. Analogously to the turbine 34, the dosing device 94 has a twin flange 96, by means of which the dosing device 92 can be coupled to the turbine 34.

In the position of the rotary slide 94 shown in FIG. 9, the exhaust air of the fuel cell stack 12, which flows to the dosing device 92 via the exhaust air strand 58 and the exhaust gas, which flows to the dosing device 92 via the exhaust gas strand 56 from the combustion chamber 38, are supplied to the first spiral channel 36 of the twin-flow turbine 34. In a not shown third position of the rotary slide 92, in which the slide is moved clockwise to the opposite stop, the exhaust gas of the combustion chamber flows together with the exhaust air of the fuel cell stack 12 only to the second spiral channel 40. In intermediate positions of the rotary slide 94, also not shown, exhaust air and exhaust gas flow to the first spiral channel 36 and the second spiral channel 40 in a mixed manner. Thereby, a high variability in the application of gas to the turbine wheel 68 of the twin-flow turbine 34 is made possible in a particularly simple and cost-efficient manner.

Hydrogen amounts that are formed in connection with an anode circulation and which can be considered virtually as leakage or lost amounts, can advantageously also be supplied to the combustion chamber 38 for combustion therein and then to the turbine 34 for a positive energy utilization.

What is claimed is:

1. An air supply unit for a fuel cell stack (12), comprising a first compressor (26) a combustion chamber (38) and a turbine (34, 74, 84), the first compressor (26) being in communication with the fuel cell stack (12) for supplying compressed air to the fuel cell stack (12) via a feed line (28) and as exhaust air from the fuel cell stack (12) to the turbine (34, 74, 84) and also via a branch line (42) to the combustion chamber (38) to which fuel can also be supplied for combustion to generate an exhaust gas flow to the turbine (34, 74, 84) for driving the turbine (34, 74, 84), and the compressor (26), the feed line (28).

2. The air supply unit according to claim 1, wherein the turbine (34, 74, 84) is in the form of a two-flow turbine, with a first spiral inlet channel (36) to which the exhaust gas from the combustion chamber (36) and a second spiral channel (40) to which the cooling gas from the fuel cell stack (12) is supplied.

3. The air supply unit according to claim 2, wherein a cross section of the second spiral channel (40) is larger than a cross section of the first spiral channel (36).

4. The air supply unit according to claim 2, wherein the first compressor (26) includes a compressor wheel and the turbine includes a turbine wheel, both mounted on a common shaft (30) rotatably supported by a bearing (70), the second spiral channel (40) being arranged closer to the bearing (70) of a shaft (30) than the first spiral channel (36).

5. The air supply unit according to claim 2, wherein the second spiral channel (40) is arranged closer to an electrical drive assembly (32) for driving the compressor (26) than the first spiral channel (36).

6. The air supply unit according to claim 1, wherein a low pressure compressor (72) is arranged upstream of the first compressor (26), and an electrical drive assembly (32) is provided for driving the low pressure compressor (72).

7. The air supply unit according to claim 1, wherein a high pressure compressor (82) is arranged downstream of the first compressor (26), and an electrical drive assembly (32) is connected to the high pressure compressor for driving the high pressure compressor (82).

8. The air supply unit according to claim 7, wherein the branch line (42) is arranged downstream of the high pressure compressor (82) in the feed line (28).

9. The air supply unit according to claim 1, wherein a dosing device (44) for adjusting an air flow that can be fed to the combustion chamber (38) is arranged at a connection point of the branch line (42) at the feed line (28).

10. The air supply unit according to claim 2, wherein the turbine (84) has a throttling device (86) for throttling or blocking at least the first spiral channel (36).

11. The air supply unit according to claim 2, wherein a dosing device (92) is arranged upstream of the turbine (34), by means of which the exhaust gas of the combustion chamber (38) can be fed selectively to at least one of the first spiral channel (36) and the second spiral channel (40) together with the exhaust air of the fuel cell stack (12).

12. The air supply unit according to claim 2, wherein the turbine (34, 74, 84) is formed as variable twin flow turbine (34, 84) or a segment turbine (74).

13. The air supply unit according to claim 1, wherein a common storage container (46) is provided for storing fuel for the combustion chamber (38) and the fuel cell stack (12).

14. The air supply unit according to claim 1, wherein an exhaust gas aftertreatment device (64) is arranged downstream of the turbine (34, 74, 84).

15. A method for operating an air supply unit (10) for a fuel cell stack (12), in which a compressor (26) compresses air fed to the fuel cell stack (12) and exhaust air of the fuel cell stack (12) is fed to a turbine (34, 74, 84) driving the compressor (26), and wherein a combustion chamber (38) is supplied with a fuel which is combusted therein to generate an exhaust gas that is supplied to the turbine (34, 74, 84)), the method comprising the steps of supplying compressed air to the fuel cell stack (12) via a feed line (28) and branching air off from the feed line (28) for supplying it to the combustion chamber (38).

16. The method according to claim 15, wherein the method is carried out by means of an air supply unit for a fuel cell stack (12), comprising a first compressor (26) a combustion chamber (38) and a turbine (34, 74, 84), the first compressor (26) being in communication with the fuel cell stack (12) for supplying compressed air to the fuel cell stack (12) via a feed line (28) and as exhaust air from the fuel cell stack (12) to the turbine (34, 74, 84) and also via a branch line (42) to the combustion chamber (38) to which fuel can also be supplied for combustion to generate an exhaust gas flow to the turbine (34, 74, 84) for driving the turbine (34, 74, 84), and the compressor (26), the feed line (28).
